(19) United States
(12) Patent Application Publication
(10) Pub. No.: US 2011/0315728 A1
(43) Pub. Date: Dec. 29, 2011

(54) CONCEALED ATTACHMENT SYSTEM FOR MOTORCYCLE SADDLEBAGS

(76) Inventor: Timothy J. Ghormley, Vass, NC (US)

(21) Appl. No.: 13/172,663

(22) Filed: Jun. 29, 2011

Related U.S. Application Data
(60) Provisional application No. 61/344,326, filed on Jun. 29, 2010.

(51) Int. Cl. B62J 9/00; B62J 7/08

(52) U.S. Cl. 224/413

(57) ABSTRACT

The concealed attachment system for motorcycle saddlebags includes a rear under-fender bracket, the saddlebags having corresponding brackets installed upon their inboard surfaces. The under-fender bracket may be either of two embodiments: one for installation on motorcycles having exposed rear fender mounting rails, and the other for installation on cycles having concealed rear fender rails, the second embodiment including replacement rails. Each under-fender bracket includes two parallel lock pin sockets to each side, the saddlebag brackets having corresponding lock pins extending upwardly therefrom. In one embodiment, the lock pin actuating ends are accessed from outside the saddlebag, while in another embodiment the lock pin actuating ends are enclosed within the bag for security. The saddlebags are installed and removed quickly and easily without tools by manipulating the actuation ends of the lock pins to engage or disengage them with the corresponding sockets of the under-fender bracket.

### CROSS-REFERENCE TO RELATED APPLICATION

This application claims the benefit of U.S. Provisional Patent Application Ser. No. 61/344,326, filed Jun. 29, 2010.

### BACKGROUND OF THE INVENTION

1. Field of the Invention

The present invention relates to motorcycle accessories, and particularly to a concealed attachment system for motorcycle saddlebags that provides a bracket permanently installed beneath the rear fender of a motorcycle that has fittings for removable attachment of saddlebags thereto.

2. Description of the Related Art

Motorcycles are well known for their general lack of luggage capacity. As a result, innumerable attachments have been developed in the past for the carriage of passengers and/or luggage or baggage on motorcycles, from aftermarket passenger seats to luggage racks that attach atop the rear fender and so-called “saddlebags” that mount laterally to each side of the rear fender, somewhat in the manner of equestrian saddlebags that straddle the flanks of a horse behind the saddle. The installation of such motorcycle saddlebags is a very popular option for many motorcycle owners, as the volume of protected storage space provided is relatively large in comparison to the relatively low profile and ease of carriage of such bags.

A common problem with such conventional motorcycle saddlebags is the need to modify the motorcycle for their installation. Invariably, at least a few additional holes must be drilled through the rear fender and/or the rear fender mounting struts or rails. Most cyclists are justifiably proud of their motorcycles, and hesitate to modify or alter their “bikes” by drilling additional holes in the structure. Yet, if they wish to carry a reasonable amount of luggage while cycling, some form of luggage or baggage carrier (saddlebags, etc.) must be installed on the motorcycle, requiring that the cycle be modified in some manner for the attachment of the luggage carrier(s).

Once the saddlebags have been installed, another problem arises when the cyclist wishes to remove the bags from the cycle. When the bags are removed, at least the holes made for mounting their attachment brackets remain, if not the brackets themselves. There are many motorcycles on the road that would be fine examples of their type, excepting the additional holes, remaining bracket(s), and/or other unsightly modifications made for saddlebags or components that were once installed and since removed. Yet, the owner of the motorcycle may wish to remove the saddlebags from time to time, e.g., for local riding where their bulk is not needed, or for other reasons. However, when conventional saddlebags are removed, the holes and/or bracket(s) remain on the bike, resulting in a less than optimally attractive appearance for the cycle. Moreover, such saddlebags conventionally require considerable time and effort for installation and removal, with various bolts and other fasteners requiring removal or installation during the process.

Thus, a concealed attachment system for motorcycle saddlebags solving the aforementioned problems is desired.

### SUMMARY OF THE INVENTION

The concealed attachment system for motorcycle saddlebags comprises a bracket having a shape conforming to the underside of the rear fender of a motorcycle, and appropriately configured saddlebags having corresponding fittings. The under-fender bracket is configured with the same hole pattern as the rear fender and its mounting struts or rails, thus avoiding the need to drill any additional holes or to modify the structure of the cycle in any way for installation of the bracket. The lower edges of the bracket are configured so that they do not extend beyond the lower edges of the motorcycle fender when the bracket is installed beneath the fender, so that there is no sign of any modification of the motorcycle for saddlebag attachment when the saddlebags are removed. The under-fender bracket is considered to be permanently installed, in the sense that it remains attached beneath the cycle fender whether the saddlebags are attached to the bracket and cycle or removed from the cycle. It will be understood that the under-fender bracket may be removed without altering the structure of the motorcycle, but such removal would require certain tools and some time to accomplish. The saddlebags to be used with the bracket include mating attachments that enable them to be attached to or removed from the under-fender bracket very quickly and easily, without need for any tools.

In a first embodiment, the system comprises an under-fender bracket formed of a sheet of metal or other suitable material, the bracket having pre-formed holes therethrough that align with the existing fender attachment holes of the fender and fender mounting rails. Two parallel, tubular saddlebag attachment sockets are provided at each edge of the bracket. Each saddlebag includes a plate or other suitable structure on the back (i.e., the inwardly facing) side thereof, with a pair of parallel, manually actuated locking pins extending upwardly therefrom. The pins insert removably into the corresponding sockets of the under-fender bracket, and lock in place within the sockets to prevent them from sliding out inadvertently and the corresponding loss of the saddlebag. Yet when removal of the bag is desired, the cyclist need only unlock the locking mechanism of the pins by hand to allow them to slide from their sockets or receptacles, and then lower and remove the bag from its attachment bracket.

In a second embodiment, the system is configured for installation on motorcycles having concealed fender mounting rails or struts, i.e., the fender installs over the outside of the rails. This system comprises a frame of two arched members configured to fit closely beneath the cycle fender, each of the members having a tubular locking pin receptacle at each end thereof. The lateral members are secured together by left and right replacement fender attachment struts or rails, with the original rails being removed for the installation of the new concealed bracket. The entire saddlebag attachment bracket structure (lateral members and rails) bolts beneath the motorcycle fender. The saddlebags attach removably to this bracket as described above for the first embodiment.

The bracket or fitting that attaches to the saddlebags may be used with any practicable type of saddlebag, either hard or soft bags. In one embodiment, the saddlebag bracket with its lock pins is installed upon the outside of the bag, thus enabling anyone to access the lock pins without need to open the bags or overcome any locking or other security mechanism. In another embodiment, the inboard wall of the saddlebag extends over the actuation ends of the lock pins, thus requiring the bag to be opened to access the actuation ends of the pins for saddlebag removal. Either bag and bracket configuration may be used with either of the above-described under-fender brackets.

These and other features of the present invention will become readily apparent upon further review of the following specification and drawings.

### BRIEF DESCRIPTION OF THE DRAWINGS

FIG. 1 is a perspective view of a first embodiment of a concealed attachment system for motorcycle saddlebags according to the present invention as seen from the right rear, the rear portion of the motorcycle being shown in broken lines and the saddlebags being omitted to show the bracket.

FIG. 2 is an exploded environmental perspective view showing an exemplary motorcycle rear fender as seen from the right rear, showing installation of the bracket of FIG. 1.

FIG. 3 is an exploded, environmental elevation view of a concealed attachment system for motorcycle saddlebags according to the present invention, the motorcycle's rear fender being shown in section, showing the installation and removable attachment of motorcycle saddlebags to the bracket of FIGS. 1 and 2.

FIG. 4 is an exploded, environmental perspective view of an alternative embodiment of a bracket for a concealed attachment system for motorcycle saddlebags according to the present invention, shown below the right rear of the motorcycle rear fender.

FIG. 5 is an exploded, environmental elevation view of a concealed attachment system for motorcycle saddlebags according to the present invention, the motorcycle's rear fender being shown in section, the view showing installation of saddlebags to the bracket of FIG. 4.

Similar reference characters denote corresponding features consistently throughout the attached drawings.

### DETAILED DESCRIPTION OF THE PREFERRED EMBODIMENTS

The concealed attachment system for motorcycle saddlebags comprises various embodiments of a system or assembly providing for the concealed attachment of a saddlebag mounting bracket within the rear fender of a motorcycle in which the bracket requires no modification of the motorcycle for installation or removal. The system further comprises the associated components of the saddlebag to enable the bag to be quickly and easily installed on and removed from the motorcycle without the need of tools.

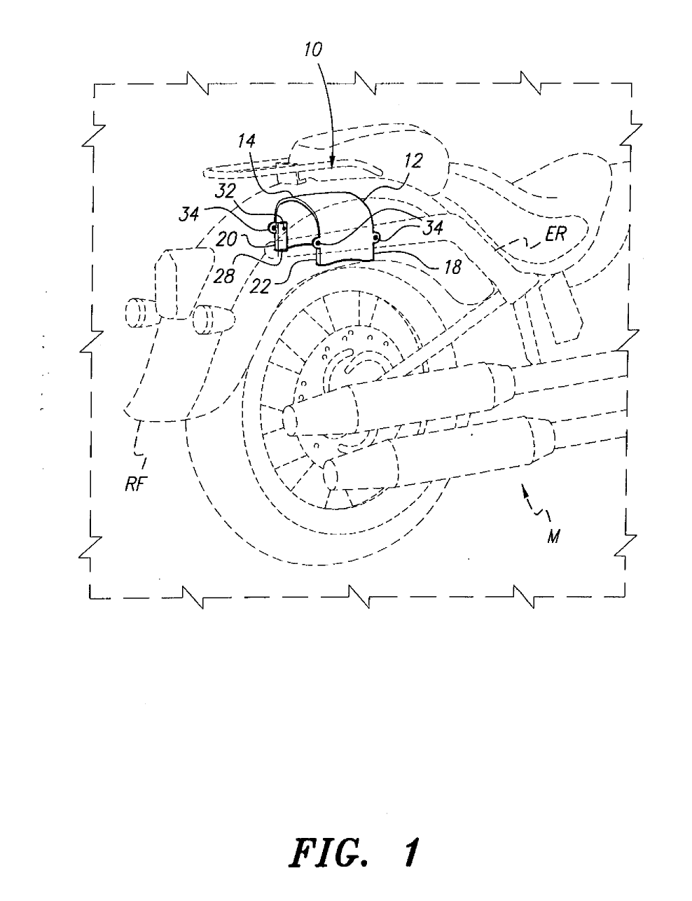

In a first embodiment, the system includes the under-fender bracket 10 shown in FIGS. 1 through 3. The fender bracket 10 comprises a single, continuous rigid plate having a shape conforming closely to the underside of the motorcycle rear fender RF so that the fender bracket 10 is completely concealed beneath the rear fender RF of the motorcycle M when installed thereunder. The fender bracket 10 has a forward portion 12 and an opposite rearward portion 14. Each portion has mutually opposed left and right extensions depending therefrom, shown as left and right forward extensions 16 and 18 extending from the forward portion 12, and left and right rearward extensions 20 and 22 extending from the rearward portion 14. It will be seen that in the under-fender bracket 10 of FIGS. 1 through 3, these forward and rearward portions 12, 14 and their extensions 16 through 22 are in the form of a single, continuous sheet of material, rather than being separate components mechanically or otherwise attached to one another.

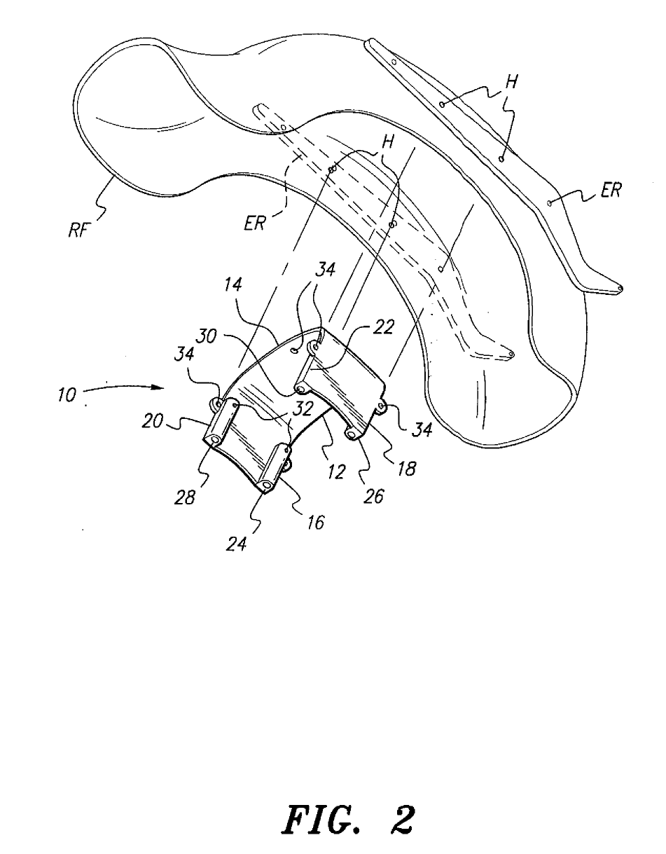

Each of the extensions 16 through 22 has corresponding tubular lock pin sockets 24 through 30, disposed along its inner surface. The two left side lock pin sockets 24 and 28 are parallel to one another, as are the two right side lock pin sockets 26 and 30. However, the corresponding left and right side lock pin sockets 24 through 30 need not necessarily be parallel to one another, but will essentially match any angular variation between the left and right sides of the rear fender RF. Each of these lock pin sockets 24 through 30 is configured to accept a corresponding saddlebag lock pin therein, as described below. Each of the sockets 24 through 30 includes a radially disposed latch passage 32 through one wall near the upper end thereof, as shown in FIGS. 1 and 2.

The under-fender bracket 10 is provided with mounting holes or passages 34 therethrough, the holes or passages 34 matching the locations of the central holes or passages H formed through the external fender mounting rails ER and the rear fender RF captured therebetween. This construction, in which the rear fender RF is captured between the two external rails ER, is conventional with most Harley-Davidson® motorcycles, and many others as well. Thus, installation of the under-fender bracket 10 is a relatively simple matter, requiring only that the existing central fender mounting bolts be removed, the under-fender bracket 10 being placed beneath the upper center of the fender RF and its holes or passages 34 being aligned with the corresponding central fender mounting holes H of the rear fender RF and its mounting rails R, and the fender mounting bolts being reinstalled. (In some instances, slightly longer bolts may be required to allow for the thickness of the under-fender bracket 10.)

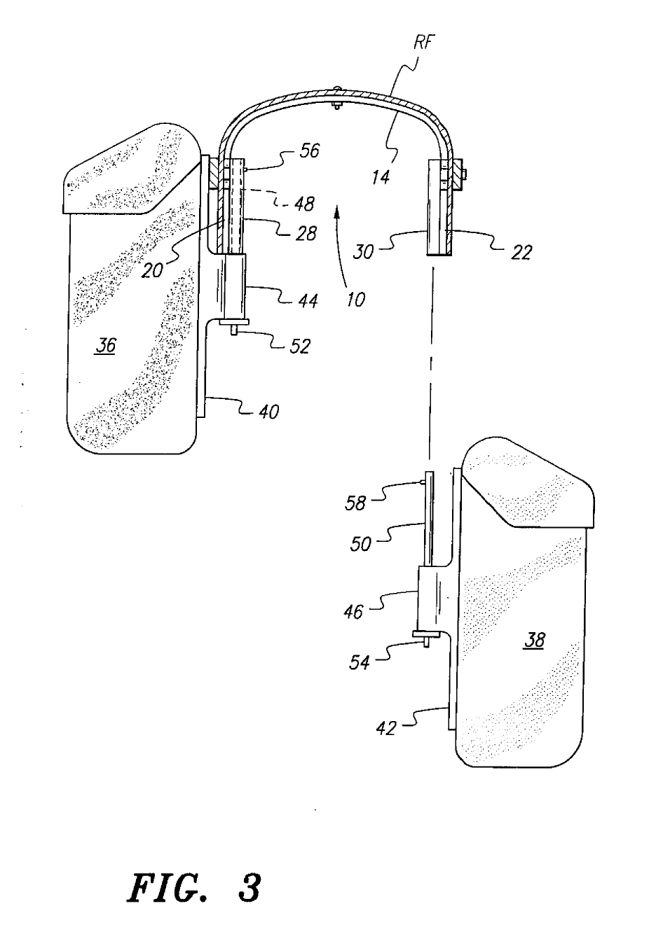

The lowermost edges of the bracket 10 are no lower than the lowermost edge of that portion of the motorcycle rear fender RF within which the bracket 10 is installed, as shown in FIGS. 1 and 3. In this manner, the bracket 10 remains completely concealed when installed, and as the motorcycle M and its rear fender RF are not modified in any manner for the installation of the bracket 10, the motorcycle M may be returned to its original configuration by removing the bracket 10, if desired.

FIG. 3 provides a rear elevation view (i.e., looking from back to front) in partial section. The motorcycle rear fender RF is shown in section to show the completed installation of the under-fender bracket 10 thereunder and the removable installation of left and right saddlebags 36 and 38 thereto. It will be understood that although FIG. 3 is a rear elevation view, this view may also represent a front elevation view in mirror image due to the laterally symmetrical nature of the various components. The saddlebags 36 and 38 may be formed of rigid materials, e.g., hard plastic, etc., or may be formed of flexible materials, e.g., flexible vinyl, leather, etc., as is conventional in motorcycle saddlebag construction.

Each saddlebag 36, 38 has a saddlebag bracket, respectively 40 and 42, permanently secured thereto. Each saddlebag bracket 40 and 42 is constructed in the general configuration of a flat plate, although the brackets 40, 42 may have some curvature if required to be congruent with the inboard wall or surface of their corresponding saddlebags 36 and 38. The left and right saddlebag brackets 40, 42 may be attached externally to the inboard walls of their respective saddlebags 36, 38 by mechanical fasteners, e.g., by bolts passing through the inboard walls of the saddlebags and their brackets, or by any other practicable means.

Each saddlebag bracket 40, 42 includes a forward and a rearward lock pin boss 44, 46 disposed inwardly therefrom, i.e., toward the center of the motorcycle when the saddlebags 36, 38 are installed thereon, and external to its saddlebag. Each lock pin boss 44, 46 has a lock pin 48, 50 extending upwardly therefrom, with the lock pin bosses 44, 46 and their lock pins 48, 50 being positioned to align with their respective forward and rearward, left and right lock pin sockets 24 through 30 of the under-fender bracket 10. The left and right rearward lock pin bosses, respectively 44 and 46, and their respective lock pins 48 and 50 are illustrated in FIG. 3. It is understood that the identical forward lock pin bosses and their lock pins are concealed by the rearward bosses 44, 46 and their pins 48, 50 in the orientation of the FIG. 3 view. In an elevation view from the front, looking to the rear, the view would be essentially a mirror image of that shown in FIG. 3, with the left side saddlebag bracket 40 being shown to the right side and the right side saddlebag bracket 42 being shown to the left. The corresponding left and right forward lock pin bosses and their lock pins would be shown extending from their respective saddlebag brackets 40 and 42. It will further be noted that due to the installed configuration of the left saddlebag 36 in FIG. 3, the left rear lock pin 48 is shown in broken lines due to its concealment within the corresponding left rear lock pin socket 28 of the under-fender bracket 10.

Each lock pin, e.g., the two rearward lock pins 48 and 50, has an actuating rod installed therein, as is conventional with such devices. Each rod terminates at its lowermost end as an actuating end, e.g., a button extending from the bottom of the respective lock pin housing. The rearward left and right actuating ends or buttons, respectively 52 and 54, are shown in FIG. 3. The actuating ends or buttons 52, 54 operate the internal rods within their pins 48 and 50, to selectively extend or retract radially extending latch pins, respectively 56 and 58, at the upper ends of their respective lock pins 48 and 50. The mechanisms of such lock pins and their radially extending latch pins are conventional, and need not be described in detail herein.

The saddlebags 36, 38 are installed by depressing the actuating ends 52, 54 of the appropriate lock pins 48, 50 to retract their corresponding latch pins, 56, 58, and inserting the lock pins 48, 50 into the corresponding lock pin sockets 28, 30 of the under-fender bracket 10. The buttons or actuating ends 52, 54 may be released as their lock pins 48, 50 are slid upwardly in their lock pin sockets 28, 30 until their latch pins 56. 58 spring outwardly to engage the corresponding latch pin passages 32 (FIGS. 1 and 2) of the lock pin sockets 28, 30, thereby securing the saddlebag 36, 38 to the under-fender bracket 10, and thus to the rear fender RF of the motorcycle M, generally as shown for the left side saddlebag 36 of FIG. 3. Removal of the saddlebag 36 is accomplished by reversing the above procedure, i.e., the actuating ends or buttons 52, 54 of the appropriate lock pins 48, 50 are depressed to retract their latch pins 56, 58, and the saddlebag 36, 38 and its lock pins 48, 50 are lowered to remove the lock pins 48, 50 from their respective lock pin sockets 28, 30.

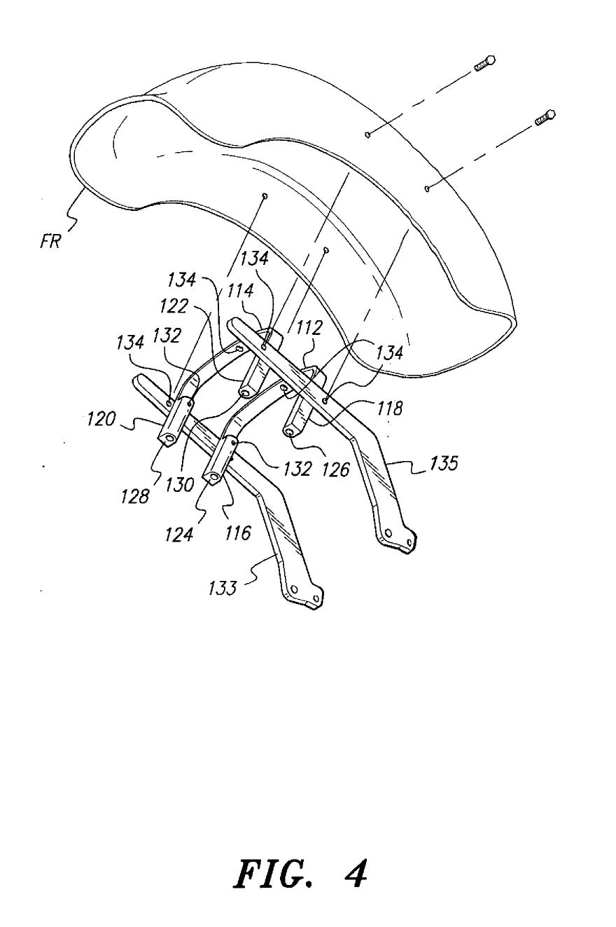

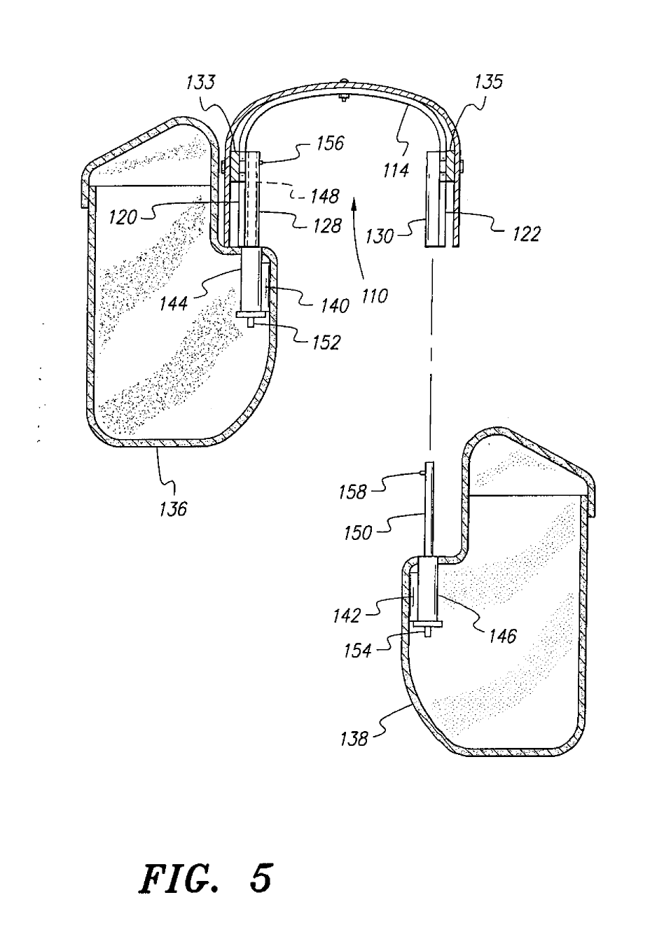

FIGS. 4 and 5 illustrate alternative embodiments of the concealed attachment system for motorcycle saddlebags. The under-fender bracket 110 of FIGS. 4 and 5 is configured for use with a motorcycle rear fender FR having internal fender attachment rails or struts. Such a fender and internal rail configuration is used with many motorcycles of Japanese manufacture, as well as some others. The forward and rearward portions of the under-fender bracket 110 respectively comprise a first fender attachment strap 112 and a second fender attachment strap 114, each strap 112, 114 having a shape conforming to the underside of the motorcycle rear fender FR. The forward strap 112 includes laterally opposed left and right extensions, respectively 116 and 118. The second strap 114 has laterally opposed left and right extensions 120 and 122. Each of the extensions 116 through 122 has a generally tubular lock pin socket, respectively 124 through 130, disposed along its inner surface, generally in the manner of the under-fender bracket 10 of FIGS. 1 through 3. Each of the sockets 124 through 130 includes a latch pin passage 132 near the upper end thereof, again in the manner of the sockets and their latch pin passages 32 of FIGS. 1 through 3.

The left side extensions 116 and 120 of the first and second straps 112 and 114 are connected to one another by a left side fender attachment strut or rail 133, with the opposite right side extensions 118, 122 of the straps being connected by a right side fender attachment strut or rail 135. These two fender attachment struts or rails 133 and 135 are at least generally parallel to one another and take the place of the conventional internally disposed fender attachment or mounting rails of such motorcycles so configured. As in the case of the bracket 10, the bracket 110 and its straps 112, 114 and attachment rails 133, 135 are concealed beneath the motorcycle rear fender FR when installed therein, with the exception of the forward ends of the attachment rails that extend forwardly of the fender and attach conventionally to the motorcycle frame or other structure.

The under-fender bracket 110, or more specifically its two fender attachment rails 133 and 135, is provided with a series of mounting holes or passages 134 therethrough. As in the case of the system of FIGS. 1 through 3, these holes or passages 134 match the locations of the central holes or passages P formed through the rear fender FR, which, in this case, encloses the under-fender bracket 110 with its rails 133 and 135. The installation of the under-fender bracket 110 is slightly more involved than the installation of the under-fender bracket 10, due to the requirement that the existing conventional fender attachment rails (not shown) be removed, with the two fender attachment struts or rails 133, 135 of the under-fender bracket 110 substituting for the removed fender attachment rails. The lowermost edges of the bracket 110 are no lower than the lowermost edge of that portion of the motorcycle rear fender FR within which the bracket 110 is installed, as shown in FIG. 5. In this manner, the bracket 110 remains substantially concealed when installed, with the only visible portion being the forward most ends of the two fender attachment rails 133 and 135. As in the case of the first embodiment bracket 10, the motorcycle and its rear fender FR are not modified in any manner for the installation of the bracket 110, thus allowing the motorcycle to be returned to its original configuration by removing the bracket 110 if so desired.

FIG. 5 is a rear elevation view similar to that of FIG. 3, i.e., looking forward, showing the attachment means for the two saddlebags 136 and 138. The saddlebags 136, 138 are generally similar to the saddlebags 36, 38 of FIG. 3 and may be formed of the same materials, i.e., a hard and rigid material or a softer and more flexible material, as desired. However, the saddlebags 136, 138 are shown in section in FIG. 5 in order to show the internal installation of their respective brackets 140 and 142 and other components. Each saddlebag 136 and 138 has an inwardly disposed, lower extension, with the attachment of the saddlebag brackets 140 and 142 being within these extensions to enclose the brackets and the actuating ends of their lock pins within the saddlebags.

Each of the brackets 140, 142 comprises a generally flat plate. As in the case of the first embodiment of FIGS. 1 through 3, the brackets 140 and 142 may be bent or curved to fit any curvature of the attached inboard wall of their respective saddlebags 136 and 138. Each saddlebag bracket 140, 142 includes a forward and a rearward lock pin boss extending therefrom. However, it will be seen in FIG. 5 that the two saddlebag brackets 140 and 142 are attached to the inner surface of the inboard wall of their respective saddlebags, i.e., they are enclosed within the saddlebags as noted further above. Their respective lock pin bosses (the two rearward bosses 144 and 146 being illustrated in the view of FIG. 5) are attached to the outwardly facing surfaces of their respective saddlebag brackets 140 and 142, i.e., toward the centers of their saddlebags.

The lock pins 148 and 150 extend upwardly from their respective bosses 144 and 146 and pass outwardly from the lower inward extensions of their respective saddlebags to extend exteriorly to the bags, as shown in FIG. 5. The lock pins 148, 150 align with their respective lock pin sockets 128 and 130 of the under-fender bracket 110, with the lock pins 148, 150 removably installing within their corresponding sockets 128, 130 to secure the saddlebags 136, 138 to the bracket 110 and thus to the motorcycle to which the bracket 110 is installed. While the view shown in FIG. 5 illustrates the rearward lock pin bosses 144 and 146 and their respective components and corresponding sockets of the bracket 110, it will be seen that a mirror image projection of FIG. 5 would illustrate the configuration of the corresponding forward components.

The lock pins, e.g., rearward lock pins 148 and 150, are generally conventional in that they include actuating rods therein. Each actuating rod terminates at its lowermost end as an actuating end, e.g., a button extending from the bottom of the respective lock pin housing. The rearward left and right actuating ends or buttons, respectively 152 and 154, are shown in FIG. 5. As in the case of the locking or latching mechanism shown in FIG. 3 and described in detail further above, the actuating ends or buttons 152, 154 operate the internal rods within their pins 148 and 150 to selectively extend or retract radially extending latch pins, respectively 156 and 158, at the upper ends of their respective lock pins 148 and 150. The mechanisms of such lock pins with their radially extending latch pins are conventional, and need not be described in detail herein.

The saddlebags 136, 138 are installed by depressing the actuating ends of the appropriate lock pins to retract their corresponding latch pins, and inserting the lock pins into the corresponding lock pin sockets of the under-fender bracket 110. However, it will be noted that the saddlebags 136 and 138 must first be opened to access the actuating ends or buttons 152 and 154, due to their secure enclosure within the saddlebags. Thus, the saddlebags 136, 138 of FIG. 5 cannot be stolen or removed by unauthorized parties without damaging the saddlebags, so long as the saddlebags are locked when they are installed on the motorcycle. The buttons or actuating ends 152, 154 may be released as their lock pins 148, 150 are slid upwardly in their lock pin sockets 128, 130 until their latch pins 156, 158 spring outwardly to engage the corresponding latch pin passages 132 (FIG. 4) of the lock pin sockets, thereby securing the saddlebag to the under-fender bracket 110 and thus to the rear fender FR of the motorcycle, generally as shown for the left side saddlebag 136 of FIG. 5. Removal of the saddlebag is accomplished by reversing the above procedure, i.e., the actuating ends or buttons of the appropriate lock pins are depressed to retract their latch pins, and the saddlebag and its lock pins are lowered to remove the lock pins from their respective lock pin sockets.

It will be recognized that the under-fender bracket 10 and external saddlebag brackets and attachments illustrated in FIGS. 1 through 3 need not necessarily be used exclusively with one another. Similarly, the bracket 110 and internal saddlebag brackets and attachments of FIGS. 4 and 5 need not be used exclusively with one another. Alternatively, the saddlebags 136 and 138 of FIG. 5 with their internal brackets and lock pin actuating ends may be used with the under-fender bracket 10 of FIGS. 1 through 3, if so desired. Similarly, the saddlebags 36 and 38 of FIG. 3, with their externally disposed brackets and lock pin mechanisms may be installed with the under-fender bracket 110 of FIGS. 4 and 5, if so desired. The only limiting factors to these alternative installations is the spacing and alignment of the various lock pin sockets of the under-fender brackets 10 and 110, and the corresponding spacing and alignment of the lock pins extending from the external saddlebag brackets 40 and 42 or the internal saddlebag brackets 140 and 142. If these various components are constructed or manufactured to provide dimensional compatibility, there are no limitations to any “mixing and matching” of these components, as described above.

It is to be understood that the present invention is not limited to the embodiments described above, but encompasses any and all embodiments within the scope of the following claims.

I claim:

1. A concealed attachment system for motorcycle saddlebags, comprising:
a fender bracket having a shape adapted to conform to the underside of the rear fender of a motorcycle, whereby the fender bracket is substantially concealed beneath the rear fender of the motorcycle when installed thereunder, the fender bracket having a forward portion and a rearward portion, each of the portions having mutually opposed left and right extensions extending therefrom;
a lock pin socket disposed along each of the extensions of the fender bracket; and
at least one saddlebag bracket, the bracket being a plate adapted for permanent attachment to a motorcycle saddlebag, the at least one saddlebag bracket having mutually parallel first and second lock pins extending upwardly therefrom, each of the lock pins releasably engaging the corresponding lock pin socket of the fender bracket.

2. The concealed attachment system for motorcycle saddlebags according to claim 1, wherein the fender bracket is a single, continuous plate.

3. The concealed attachment system for motorcycle saddlebags according to claim 1, wherein:
the forward portion of the fender bracket comprises a first fender attachment strap;
the rearward portion of the fender bracket comprises a second fender attachment strap, each of the straps having mutually opposed left and right side extensions, each of the straps being configured for concealment beneath the rear fender of the motorcycle when installed thereunder; and
left and right side fender attachment struts, each of the struts being connected to the corresponding extensions of the first strap and the second strap, each of the struts being adapted for concealment beneath the rear fender of the motorcycle when installed thereunder.

4. The concealed attachment system for motorcycle saddlebags according to claim 1, further including at least one saddlebag, the saddlebag bracket being installed thereto.

5. The concealed attachment system for motorcycle saddlebags according to claim 4, wherein each of the lock pins includes a lowermost actuating end, the actuating end being disposed externally to the saddlebag.

6. The concealed attachment system for motorcycle saddlebags according to claim 4, wherein each of the lock pins includes a lowermost actuating end, the actuating end being enclosed within the saddlebag.

7. The concealed attachment system for motorcycle saddlebags according to claim 4, wherein the at least one saddlebag is constructed as a rigid shell.

8. The concealed attachment system for motorcycle saddlebags according to claim 4, wherein the at least one saddlebag is constructed from flexible sheet material.

9. A concealed attachment system for motorcycle saddlebags, comprising:
a fender bracket having a shape conforming to the underside of the rear fender of a motorcycle, whereby the fender bracket is substantially concealed beneath the rear fender of the motorcycle when installed thereunder, the fender bracket being a single, continuous plate, the plate having a forward portion, a rearward portion, and mutually opposed left and right flanges depending therefrom;
mutually parallel first and second lock pin sockets disposed along the forward portion and the rearward portion, respectively, of each of the flanges of the fender bracket; and
at least one saddlebag bracket, the bracket being a plate adapted for permanent attachment to a motorcycle saddlebag, the at least one saddlebag bracket having mutually parallel first and second lock pins extending upward therefrom, each of the lock pins releasably engaging the corresponding lock pin sockets of the fender bracket.

10. The concealed attachment system for motorcycle saddlebags according to claim 9, further including at least one saddlebag, the saddlebag bracket being installed thereto.

11. The concealed attachment system for motorcycle saddlebags according to claim 10, wherein each of the lock pins includes a lowermost actuating end, the actuating end being disposed external to the saddlebag.

12. The concealed attachment system for motorcycle saddlebags according to claim 10, wherein each of the lock pins includes a lowermost actuating end, the actuating end being enclosed within the saddlebag.

13. The concealed attachment system for motorcycle saddlebags according to claim 10, wherein the at least one saddlebag is constructed of a rigid shell.

14. The concealed attachment system for motorcycle saddlebags according to claim 10, wherein the at least one saddlebag is constructed from flexible sheet material.

15. A concealed attachment system for motorcycle saddlebags, comprising:
a fender bracket having a shape conforming to the underside of a rear fender of a motorcycle, the fender bracket including;
spaced apart first and second fender attachment straps, each of the straps having mutually opposed left and right side extensions, the straps being adapted for concealment beneath the rear fender of the motorcycle when installed thereunder;
left and right side fender attachment struts, each of the struts being connected to the corresponding extensions of the first and second straps, each of the struts being adapted for concealment beneath the rear fender of the motorcycle when installed thereunder;
mutually parallel first and second lock pin sockets disposed along each of the extensions of the first and second straps, respectively; and
at least one saddlebag bracket having a plate adapted for permanent attachment to a motorcycle saddlebag, the at least one saddlebag bracket having mutually parallel first and second lock pins extending upward therefrom, the lock pins releasably engaging the corresponding lock pin sockets of the straps.

16. The concealed attachment system for motorcycle saddlebags according to claim 15, further including at least one saddlebag, the saddlebag bracket being installed thereto.

17. The concealed attachment system for motorcycle saddlebags according to claim 16, wherein each of the lock pins includes a lowermost actuating end, the actuating end being disposed external to the saddlebag.

18. The concealed attachment system for motorcycle saddlebags according to claim 16, wherein each of the lock pins includes a lowermost actuating end, the actuating end being enclosed within the saddlebag.

19. The concealed attachment system for motorcycle saddlebags according to claim 16, wherein the at least one saddlebag is constructed of a rigid shell.

20. The concealed attachment system for motorcycle saddlebags according to claim 16, wherein the at least one saddlebag is constructed from flexible sheet material.
